(19) United States
(12) Patent Application Publication
(10) Pub. No.: US 2026/0080054 A1
(43) Pub. Date: Mar. 19, 2026

(54) SELECTIVELY DISABLING PERMISSIONS

(71) Applicants: Apple Inc., Cupertino, CA (US); Arm Limited, Cambridge (GB)

(72) Inventors: Alexander Donald Charles CHADWICK, Cambridge (GB); Jeff GONION, Campbell, CA (US); Bernard J. SEMERIA, Palo Alto, CA (US)

(21) Appl. No.: 19/325,379

(22) Filed: Sep. 10, 2025

Related U.S. Application Data
(60) Provisional application No. 63/695,979, filed on Sep. 18, 2024.

(51) Int. Cl. G06F 21/54; G06F 12/14

(52) U.S. Cl. CPC G06F 21/54; G06F 12/145; G06F 12/1483

(57) ABSTRACT

An apparatus is provided in which memory security circuitry responds to a branch by determining whether there is permission for the execution context that executes the branch to branch to the target of the branch and taking an error action in the absence of such permission. Exception handling circuitry responds to an exception by branching to an exception handling routine and disabling circuitry disables the memory security circuitry in response to the exception.

This application claims the benefit of priority to U.S. Provisional App. Ser. No. 63/695,979, titled “SELECTIVELY DISPLAYING PERMISSIONS,” filed on Sep. 18, 2024, which is incorporated herein by reference in its entirety.

### TECHNICAL FIELD

The present disclosure relates to data processing.

### DESCRIPTION

Exceptions can often be taken at any point during the execution of program code. However, this can be problematic when it is desirable to enforce permissions relating to which code is permitted to access which other code.

### SUMMARY

Viewed from a first example configuration, there is provided an apparatus comprising: memory security circuitry configured to respond to a branch by determining whether there is permission for the execution context that executes the branch to branch to the target of the branch and to take an error action in the absence of such permission; exception handling circuitry configured to respond to an exception by branching to an exception handling routine; and disabling circuitry configured to disable the memory security circuitry in response to the exception.

Viewed from a second example configuration, there is provided a method comprising: responding, using memory security circuitry, to a branch by determining whether there is permission for the execution context that executes the branch to branch to the target of the branch and taking an error action in the absence of such permission; responding to an exception by branching to an exception handling routine; and disabling the memory security circuitry in response to the exception.

Viewed from a third example configuration, there is provided a computer program for controlling a host apparatus to provide an instruction execution environment, the computer program comprising: permission enforcement program logic configured to respond to a branch by determining whether there is permission for the execution context that executes the branch to branch to the target of the branch and to take an error action in the absence of such permission; exception handling program logic configured to respond to an exception by branching to an exception handling routine; and disabling program logic configured to disable the memory security circuitry in response to the exception.

### BRIEF DESCRIPTION OF THE DRAWINGS

The present invention will be described further, by way of example only, with reference to embodiments thereof as illustrated in the accompanying drawings, in which:

FIG. 1 schematically illustrates a data processing apparatus embodying the present techniques;

FIG. 2 schematically illustrates a data processing apparatus embodying the present techniques;

FIG. 3 schematically illustrates a data processing apparatus embodying the present techniques;

FIG. 4 schematically illustrates a data processing apparatus embodying the present techniques;

FIGS. 5A and 5B schematically illustrate a permission disables table and example entries;

FIG. 6 schematically illustrates a data processing apparatus embodying the present techniques;

FIG. 7 schematically illustrates a look-up process using an instruction region table to yield a permissions index;

FIG. 8 schematically illustrates a data processing apparatus embodying the present techniques;

FIG. 9 is a flow diagram showing a sequence of steps;

FIG. 10 schematically illustrates a simulator implementation that may be used;

FIG. 11 illustrates an example apparatus in accordance with some examples;

FIG. 12 shows a timeline of how such a disabling process might work;

FIG. 13 illustrates a more complicated example in which the exception handling routine is paged out when it is called;

FIG. 14 illustrates a flow chart that shows a method of data processing in accordance with some examples;

FIG. 15 illustrates a variant in which only certain types of exception cause the memory security circuitry to be disabled; and

FIG. 16 schematically illustrates a simulator implementation that may be used.

### DESCRIPTION OF EXAMPLE EMBODIMENTS

Before discussing the embodiments with reference to the accompanying figures, the following description of embodiments is provided.

In accordance with one example configuration there is provided an apparatus comprising: memory security circuitry configured to respond to a branch by determining whether there is permission for the execution context that executes the branch to branch to the target of the branch and to take an error action in the absence of such permission; exception handling circuitry configured to respond to an exception by branching to an exception handling routine; and disabling circuitry configured to disable the memory security circuitry in response to the exception.

One way of providing security when executing instructions is to assess whether it is permissible for a branch to occur from a block of code (e.g. a function) to a block of code containing a target (e.g. another function). This makes it possible to prevent rogue software from entering code that is protected or otherwise restricted and also makes it difficult for an attacker to modify legitimate code so as to execute protected or restricted code—or even code for which there is no legitimate reason for that code to be executed. A situation in which this can cause problems is with exceptions because in theory it should be possible for an exception to be taken (almost) everywhere since in most cases an exception could be raised at any time and generally should be handled as soon as possible. In these cases, although the currently executing code should not have the ability to directly call the exception handler, it is nonetheless necessary for the exception handler to be called if an exception occurs. The present technique therefore temporarily disables the memory security circuitry when an exception is legitimately raised.

In some examples, the disabling circuitry is configured to disable the memory security circuitry for one instruction. As explained above, disabling the memory security circuitry is appropriate in order to allow the exception to be taken. The memory security circuitry therefore only need occur until one instruction is executed.

In some examples, the one instruction is the cause of the branching to the exception handling routine. Consequently, the branch to the exception handling routine itself is permitted regardless of what permissions are held by the code that was executing at the time the exception was taken. In particular, the check of the permissions of that code is avoided so that regardless of the permissions that the code has, a branch to the exception handling routine in response to an exception occurring will be permitted.

In some examples, the one instruction is a first instruction of the exception handling routine. Consequently, where a permissions check might otherwise have prevented execution of the exception handling routine by virtue of this first instruction of the exception handling routine being determined to be forbidden to be branched to from the currently executing code, the disabling of the memory security circuitry for this one instruction ensures that the branch to the exception handling routine will be permitted.

In some examples, the apparatus comprises a current state register, wherein the disabling circuitry is configured to disable the memory security circuitry in response to the exception in dependence on a disabling bit of the current state register. Accordingly the suppression of the memory security circuitry can be controlled by the mechanism of setting/unsetting this bit.

In some examples, the apparatus comprises: a saved state register, wherein in response to the exception handling routine being paged out and a memory fault being raised, the enablement state of the memory security circuitry is saved to the saved state register and restored when the exception handling routine is paged in. In some situations, an exception will be raised but the software routine that is to be invoked when that exception is triggered is paged out. In this situation, the exception handling routine is not currently in active memory and must therefore be retrieved from elsewhere (e.g. a backing store). This causes a page fault to be raised so that the retrieval of the exception handling routine can be performed. In this situation, the exception handling routine that was supposed to be invoked has not yet occurred. Therefore, the saved state register is used to store the fact that the memory security circuitry should be disabled. In this way, the memory security circuitry can be re-enabled and when the exception handling routine is retrieved into active memory, the state of the memory security circuitry can be set based on the state stored in the saved state register, e.g. it can be redisabled, so that the exception handling routine can be invoked without the permission check taking place. Note that the memory fault routine may be partly implemented using hardware. For instance, hardware may be responsible for saving the state (e.g. at the direction or instruction of the memory fault routine).

In some examples, the disabling circuitry is configured to re-enable the memory security circuitry after the one instruction has been executed. Thus having performed (for instance) the branch to the exception handling routine, further branches and operations are dependent on the current code being executed. The exception to the permission circuitry thus only lasts until the transfer to the exception handling routine has taken place.

In some examples, the disabling circuitry is configured to re-enable the memory security circuitry in response to a further control flow instruction. Rather than immediately re-enable the memory security circuitry, these examples recognise that until a control flow instruction is encountered there is no further permission check to be performed since it is assumed that the apparatus arrived at the exception handling routine correctly. Consequently, rather than continually checking permissions, it can simply be assumed that the permissions are met. When a control flow instruction is next encountered (which could be a branch instruction or a return-from-branch instruction for instance), the situation could be different and so the memory security circuitry is re-enabled so that a permission check can be made. Note that in some examples, not all permission checks are disabled. Other permission checks that go beyond determining whether a control flow instruction can be executed could still be performed in these circumstances.

In some examples, the memory security circuitry is configured to determine whether there is permission for the execution context that executes the branch to branch to the target of the branch after the branch has been performed. The permission check therefore does not occur immediately but occurs after the branch has already taken place. This is useful for situations where other permission checks take place—for instance whether particular data can be read or written to. By performing the permission check at the target, the permission checking can be simplified since all permission checking can be carried out at the same place in the (micro) architecture/pipeline.

In some examples, the error action comprises rewinding the branch as if it had not taken place. If the check occurs at the callee rather than the caller (and hence the branch has already been performed) and if it is determined that permission to perform the branch was not provided then an appropriate action can include restoring the program counter value to correspond with the source of the branch. This process may also involve flushing the pipeline if speculative execution is taking place so that instructions along the correct branch are executed.

In some examples, the memory security circuitry is configured to store, for the execution context that executes the branch, whether the execution context is permitted to read, write and/or execute in relation to a memory location. The execute permission may be used to perform a branch or control flow instruction, the read permission may be used to read a data location and the write permission may be used to store at a data location. The read and write permissions therefore relate to memory locations at which data is stored whereas the execute permission relates to a memory location of an instruction (or a block of instructions).

In some examples, when the disabling circuitry has disabled the memory security circuitry, the execution context that executes the branch is permitted to branch to the exception handling routine regardless of whether the memory security circuitry stores an indication that the execution context is prohibited from branching to the exception handling routine. In these examples, even though the execution context that executed the branch is not permitted to branch to the exception handling routine, such a branch is nevertheless permitted by virtue of the memory security circuitry being disabled.

In some examples, the error action comprises raising an exception. In these examples, a consequence of the caller trying to call a function (or instruction address) to which access is not permitted is for an exception to be called. It will be appreciated, therefore, that allowing an exception handling routine to be executed when an exception needs to be taken (by disabling the memory security circuitry) is therefore important. In these situations the order of events would cause the memory security circuitry to detect that an inappropriate access attempt were taking place and cause an exception to be raised. This in turn would lead to a disabling of the memory security circuitry by the disabling circuitry and thereby allow the exception handling routine to be executed in order for the inappropriate access to be responded to via an exception.

In some examples, the memory security circuitry is configured to determine whether there is permission for the execution context that executes the branch to branch to the target of the branch based on a program counter value of the execution context. The permissions can be determined (at least in part) on a program counter value of the instruction that causes a branch to the target.

In some examples, the disabling circuitry is configured to disable the memory security circuitry in response to the exception in dependence on a type of the exception. It may be the case that there are some exceptions that cannot occur at any point in the code and where it may be desirable for a particular execution level to be enforced before the exception handling code can be accessed. In these situations, the disabling circuitry may itself not execute depending on the type of exception.

Particular embodiments will now be described with reference to the figures.

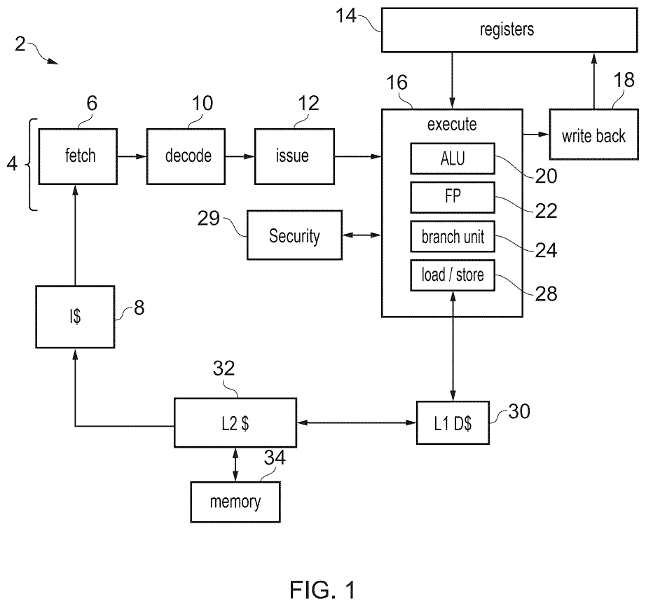

FIG. 1 illustrates a data processing apparatus 2 in accordance with some embodiments. The apparatus 2 has a processing pipeline 4 that includes a number of pipeline stages. In this example, the pipeline stages include: a fetch stage 6 for fetching instructions from an instruction cache 8; a decode stage 10 for decoding the fetched program instructions to generate micro-operations (decoded instructions) to be processed by remaining stages of the pipeline; an issue stage 12 for checking whether operands required for the micro-operations are available in a register file 14 and issuing micro-operations for execution once the required operands for a given micro-operation are available; an execute stage 16 for executing data processing operations corresponding to the micro-operations, by processing operands read from the register file 14 to generate result values; and a writeback stage 18 for writing the results of the processing back to the register file 14. It will be appreciated that this is merely one example of possible pipeline architecture and other systems may have additional stages or a different configuration of stages. For example, in an out-of-order processor an additional register renaming stage could be included for mapping architectural registers specified by program instructions or micro-operations to physical register specifiers identifying physical registers in the register file 14. In some examples, there may be a one-to-one relationship between program instructions decoded by the decode stage 10 and the corresponding micro-operations processed by the execute stage. It is also possible for there to be a one-to-many or many-to-one relationship between program instructions and micro-operations, so that, for example, a single program instruction may be split into two or more micro-operations, or two or more program instructions may be fused to be processed as a single micro-operation.

The execute stage 16 includes a number of processing units, for executing different classes of processing operation. In the example shown, the execution units include an arithmetic/logic unit (ALU) 20 for performing arithmetic or logical operations; a floating-point unit 22 for performing operations on floating-point values; a branch unit 24 for evaluating the outcome of branch operations and adjusting the program counter which represents the current point of execution accordingly; and a load/store unit 28 for performing load/store operations to access data in a memory system 8, 30, 32, 34. In this example, the memory system includes a level one data cache (L1D$) 30, a level one instruction cache (L1I$) 8, a shared level two cache (L2$) 32, and main system memory 34. It will be appreciated that this is just one example of a possible memory hierarchy and other arrangements of caches can be provided. Further shown is a security unit 29 that is configured to determine, for operations to be performed by the execute unit 16, whether the operations are permitted. The specific types of processing unit 20 to 28 shown in the execute stage 16 are just one example, and other implementations may have a different set of processing units or could include multiple instances of the same type of processing unit so that multiple micro-operations of the same type can be handled in parallel. It will be appreciated that FIG. 1 is merely a simplified representation of some components of a possible processor pipeline architecture, and the processor may include many other elements not illustrated for conciseness, such as branch prediction mechanisms or address translation or other memory management mechanisms.

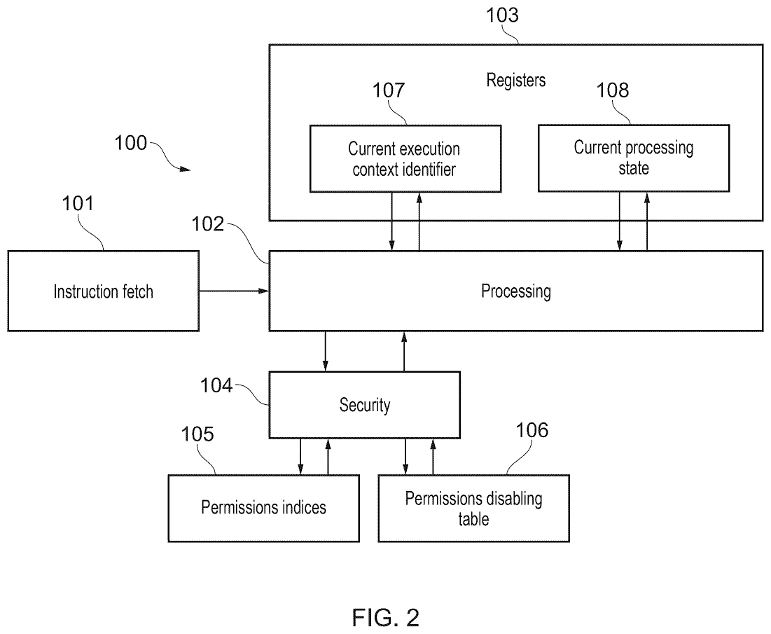

FIG. 2 schematically illustrates in more detail some key components of an example apparatus 100 in accordance with the present techniques. The apparatus 100 comprises instruction fetch circuitry 101 that is configured to fetch a sequence of instructions from the memory system for execution by the processing circuitry 102. In a manner with which the person of ordinary skill in the art will be familiar, the sequence of instructions fetched may be dictated by a program counter value corresponding to memory addresses at which those instructions are stored, whereby the program counter value is generally incremented to indicate the next instruction to be fetched and executed, except when it is caused to jump to a different section of program code, for example when a branch is encountered. Some of the instructions executed by the processing circuitry define an operation specifying a target register. Whether the processing circuitry is permitted to execute the instruction and/or to access the target register is controlled by the security circuitry 104. Data processing performed by the processing circuitry 102 comprises accessing data values temporarily stored in the registers 103. The registers 103 hold data values with a variety of purposes, for example whilst some register data values, such those in the current processing state register file 108, hold values indicative of a current processing state of the processing circuitry and dictate the current operational configuration of the apparatus, other register data values are obtained by retrieval from the memory system as the subject of the data processing operations that the processing circuitry carries out. When modified by the data processing operations these data values may then be written back to the memory system. The figure further shows the current execution context identifier register 107 that holds a current execution context identifier indicative of a current process that has caused the current instruction to be fetched. The security circuitry 104 is configured to determine, for a given instruction, whether that instruction itself is permitted to be executed or not, and whether a target register specified by the instruction is permitted to be accessed in the manner specified by the instruction, based on the originating particular process and program code, the execution of which comprises this instruction. To do this the security circuitry 104 firstly determines, based on the instruction fetch address, a current region identifier. It then determines a permissions index, based on the current region identifier and the execution context identifier provided by the current execution register 107. Permissions indices (from which the permissions index is selected) may be available to the security circuitry is a variety of ways as generally shown by the permissions indices block 105. The security circuitry 104 then uses the permissions index to index into a permissions disabling table 106 to determine a set of permission disables. Accordingly, the set of permission disables provides a fine-grained control over whether the subject operation is allowed or prohibited, in particular by enabling specific actions to be prohibited. Consequently, the security circuitry can then either allow the operation to proceed or signal a response to the processing circuitry indicating that the operation is prohibited.

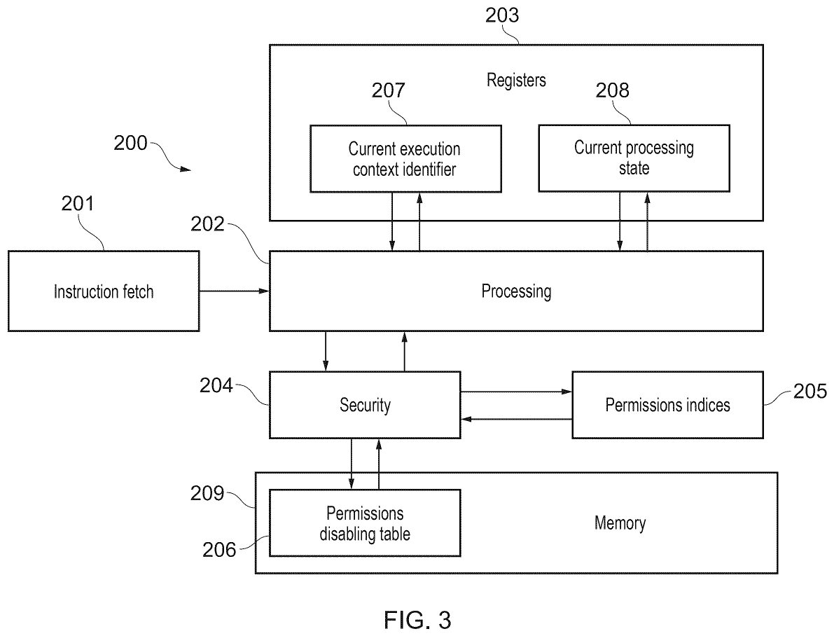

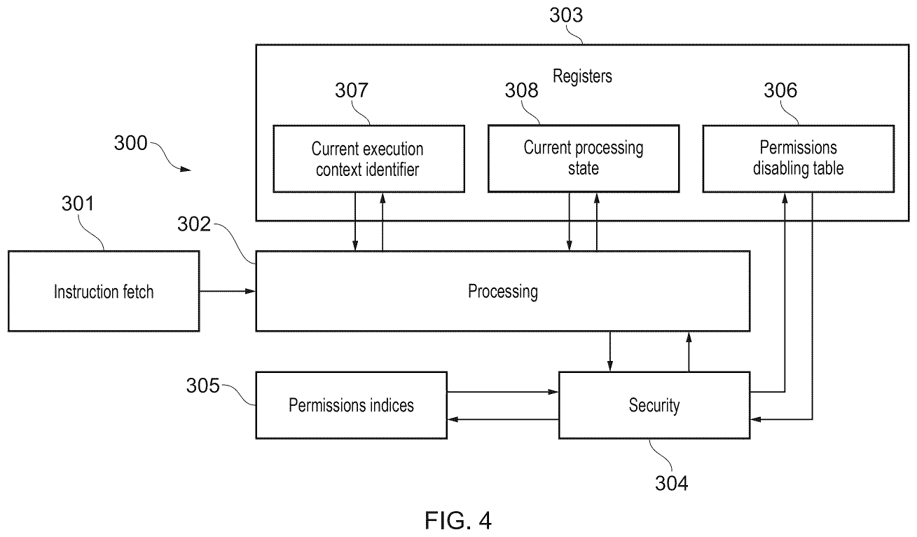

The permissions disabling table may be provided to be accessible to the security circuitry 104 in various ways. FIGS. 3 and 4 are similar to FIG. 2 and indeed within the apparatus 100/200/300, the instruction fetch circuitry 101/201/301, the processing circuitry 102/202/302, the current execution context identifier register 107/207/307, and the current processing state register 108/208/308 within the set of registers 103/203/303, and the permissions indices storage 105/205/305 are configured and operate as described with reference to FIG. 2. In the example of FIG. 3, the security circuitry 204 is arranged to access a permissions disabling table 206 that is stored in memory 209 and thus will be accessed by the security circuitry 204 via usual memory access mechanisms. In the example of FIG. 4, the security circuitry 304 is arranged to access a permissions disabling table that is stored in one or more registers 306 in the registers 303.

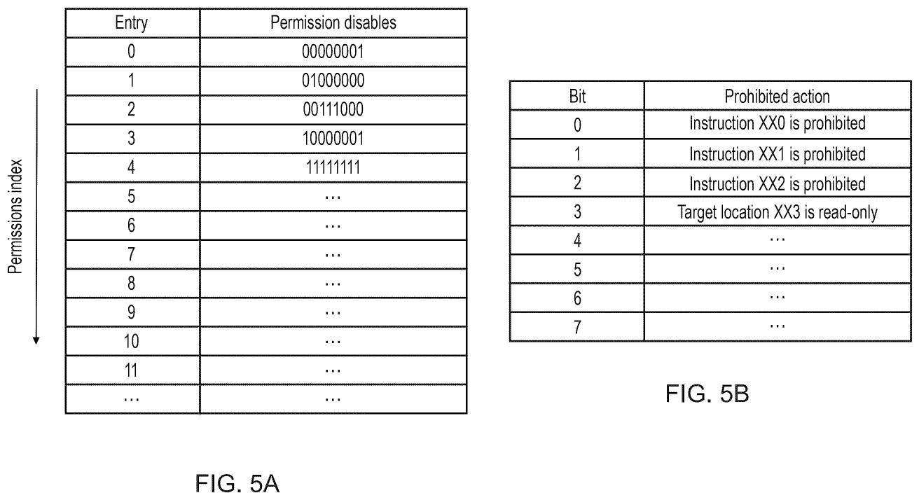

FIGS. 5A and 5B illustrate an example configuration of a permissions disabling table. FIG. 5A shows a permissions disabling table comprising multiple entries, whereby an entry of the permissions disabling table is selected by the use of the permissions index. Each entry comprises a data value, which in this illustrated example comprises 8 bits. The particular length of the data value is not significant and in other examples different data value lengths may be chosen. When the permissions disabling table is accessed (by means of indexing using the permissions index) the selected data value is retrieved. FIG. 5B illustrates the semantic interpretation of the data value, wherein each bit of the data value corresponds to a particular prohibited action. Examples are shown of the execution of particular instructions or instructions types being prohibited, as well as a specified target location being restricted to being read-only (where it would otherwise also be write-accessible). The present techniques are not limited to any particular set of prohibitions being defined to correspond to the bits of the data values of the permissions disabling table. Nevertheless, purely by way of example, the prohibitions could include:
A specific instruction (i.e. as characterised by a specific opcode)
A type of instruction (i.e. any instruction which meets the type definition)
Any instruction which initiates a specific type of action
Normal operation of a specific instruction or instruction type (e.g. the instruction is allowed to execute, but a defined response is triggered, such as the generation of an exception)
Certain registers (or certain bits of a specified register) may not be written to (i.e. are constrained to be read-only for the executing instruction).

By way of further example the (types of) instructions which may fall into at least one of the above prohibition categories may include:
a supervisor call instruction which is configured to trigger an exception that causes the apparatus to transition from an unprivileged mode to a privileged mode
a pointer authentication instruction that is configured to authenticate cryptographically the validity of a pointer
a guarded control stack pointer modifying instruction that is configured to modify a guarded control stack pointer
an allocation tag storing instruction that is configured to store a security verification value in association with an allocated region of memory
an exception return instruction

Any register may be subjected to the above-mentioned read-only constraint, but purely by way of example the registers may be translation-related registers, i.e. those that control aspects of address translation such as:
a translation table base register
a translation control register
a permission indirection register
a permission overlay register
an (auxiliary) memory attribute indirection register
a system control register

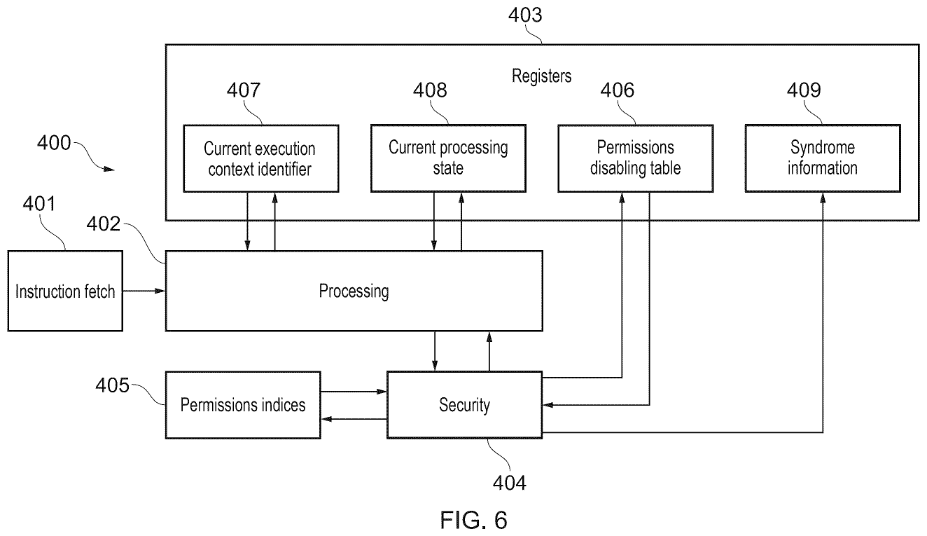

FIG. 6 schematically illustrates a further example configuration of an apparatus 400, which is also similar to the apparatus 100 of FIG. 2 and indeed the instruction fetch circuitry 101/401, the processing circuitry 102/402, the current execution context identifier register 107/407 and the current processing state register 108/408 within the set of registers 103/403, and the permission indices storage 105/405 are configured and operate as described with reference to FIG. 2. In the example of FIG. 6, the memory security circuitry 404 is arranged to access a permissions disabling table that is stored in one or more registers 406 in the registers 403. Also, in cases in which the memory security circuitry 404 determines the request is prohibited, the prohibited instruction response may comprise the generation of an exception and the security circuitry 404 can then store information in a syndrome information register 409 of the register circuitry 403 indicative of a cause of the exception. In other cases in which the memory security circuitry 404 determines the request is prohibited, the prohibited instruction response comprises causing the instruction to be transformed to execute as a different instruction (i.e. one that is considered more benign). In still other examples the prohibited instruction response comprises causing an exception to be taken that is reported as though the instruction (i.e. its encoding) does not exist (i.e. it is “undefined”).

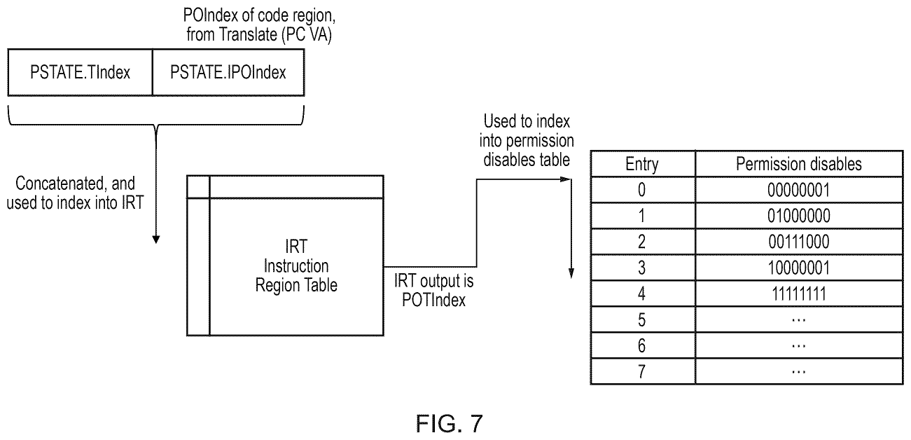

FIG. 7 illustrates the manner in which a permissions index is determined and used to index into a permissions disabling table in accordance with some examples. In a first stage the permissions index is determined, wherein information relating to the current process and the particular code being executed is used to determine a permissions index. To support this, memory pages are annotated (in their page table entries) with a permission overlay index (POIndex). Also, the processor state (here, PSTATE) held in the registers to define the current processing state is augmented by a temporal index field (TIndex). TIndex is controlled to correspond to the current execution context and, for example, is modified when the exception (privilege) level changes, such as on exception entry to a more privileged exception level or on legal exception return to a less privileged exception level. On exception entry/return without a change in exception level, TIndex is unchanged. The permission overlay index forms part of the translation information accessed when a virtual address is translated into a physical address. In the first stage, two identifiers PSTATE.TIndex and PSTATE.IPOIndex are derived. PSTATE.TIndex identifies what process is currently executing and PSTATE.IPOIndex (obtained by translating the program counter virtual address) identifies the particular code being executed. PSTATE.TIndex and PSTATE.IPOIndex are concatenated and used to index into an instruction region table (IRT). The IRT of this example is a one-dimensional table, with each entry comprising a permissions index (POTIndex). Note that there are distinct instruction region tables for each exception level. In the second stage the permissions index (POTIndex) is used to index into the permission disables table to select a set of permission disables (as described above with reference to FIGS. 5A and 5B).

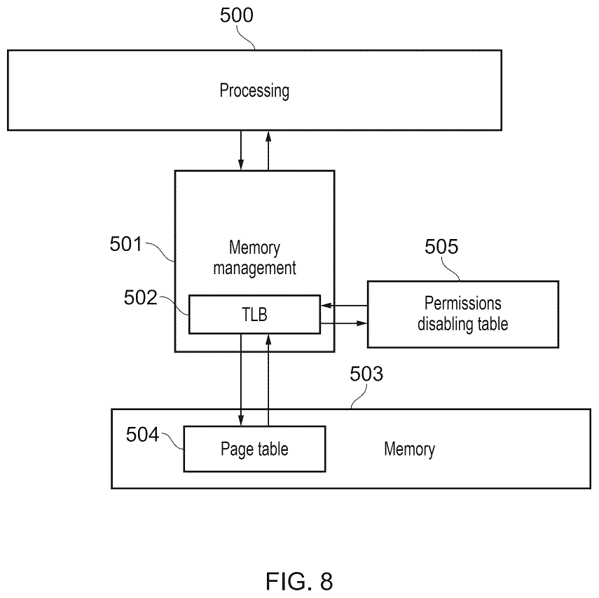

FIG. 8 schematically illustrates part of an apparatus comprising a memory management unit that controls access permissions in accordance with some examples. Access to memory initiated by instructions executed by the processing circuitry 500 are handled by the memory management unit (MMU) 501. The MMU 501 controls the process which translates virtual addresses (VA) used by the processing circuitry 500 into physical addresses used in the memory system being accessed. Page tables 504 stored in memory define the translations and further provide some access permissions associated with the regions of memory being accessed. Address translation information retrieved from the page tables is cached in the translation lookaside buffer (TLB) 502 in order to avoid the latency associated with a full page table walk (which is necessary the first time that a given translation is required) for repeatedly accessed memory locations. The MMU 501 determines a set of permissions information for access requests from the processing circuitry 500 that it handles. This set of permissions information may derive at least in part from page table access permissions information obtained from a page table entry of the page table 504. The application of the set of permission disables to the set of permissions information produces a reduced set of permissions information. Note that the permissions overlay information obtained from the POT can be variously combined with the page table derived access permissions. This combination can be additive, i.e. that any action permitted by either the page table derived access permissions or the permissions overlay information is allowed (unless prohibited by a permissions disable). Alternatively, the combination can be subtractive, i.e. that for an action to be allowed it must be permitted by both the page table derived access permissions and the permissions overlay information (and also not prohibited by a permissions disable).

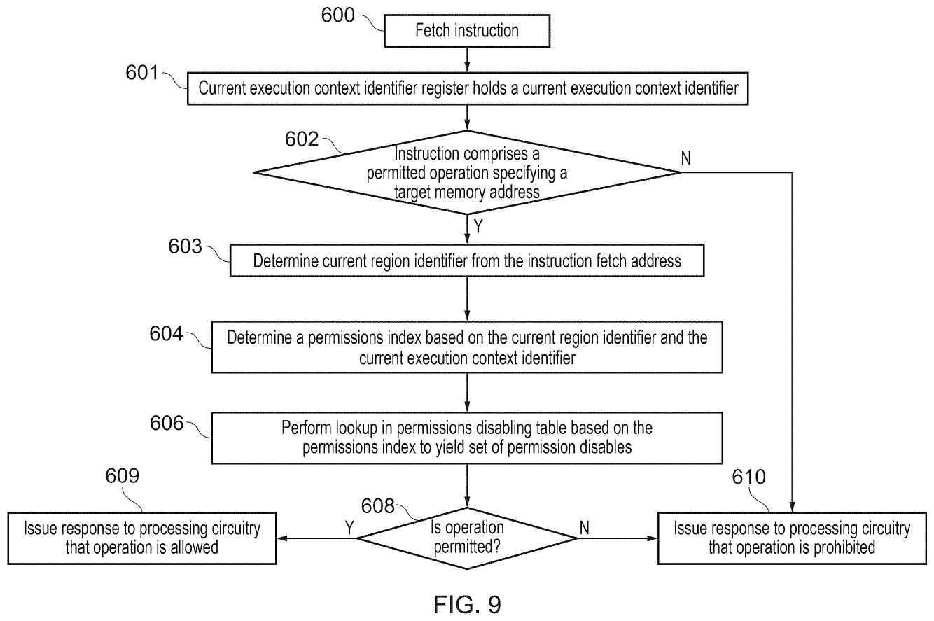

FIG. 9 is a flow diagram showing a sequence of steps which are taken in accordance with the method of some examples. The sequence shown begins at step 600 where an instruction is fetched and step 601 shows the current execution context identifier register holding a current execution context identifier. Next an optional step 602 may be present, at which it can be determined (e.g. by memory security circuitry) if the instruction comprises a permitted operation specifying a target memory address. This may for example be performed with reference to a corresponding page table entry indicating some access permissions for this target memory address. If at step 602 it is determined that the operation would be in violation of those access permissions then the flow proceeds directly to step 610 at which a response is issued (e.g. by the memory security circuitry) to the processing circuitry indicating that the operation is prohibited. When the access permissions permit the operation at the target memory address, the flow proceeds from step 602 to step 603 (or when step 602 is not present the flow proceeds directly from step 601 to step 603) at which a current region identifier is determined from the instruction fetch address. Then at step 604 a permissions index is determined based on the current region identifier and the current execution context identifier. Next at step 606 a look up in a permissions disabling table is performed using the permissions index to yield a set of permission disables information. It is then determined at step 608 whether the request is permitted to proceed. If it is not then the flow proceeds to step 610 at which a response is issued (e.g. by the memory security circuitry) to the processing circuitry indicating that the request is prohibited. When the request is permitted the flow proceeds to step 609, issuing a response to the processing circuitry that the request is allowed. Note that an explicit “allowed” notification at step 609 may be omitted, and the request is simply allowed to proceed.

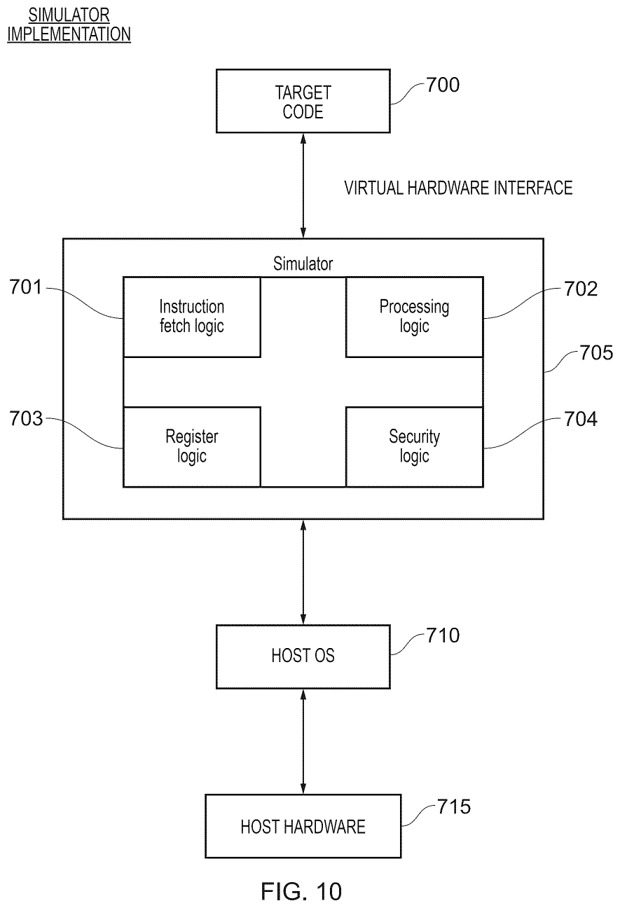

FIG. 10 schematically illustrates a simulator implementation that may be used. Whilst the earlier described embodiments implement the present invention in terms of apparatus and methods for operating specific processing hardware supporting the techniques concerned, it is also possible to provide an instruction execution environment in accordance with the embodiments described herein which is implemented through the use of a computer program. Such computer programs are often referred to as simulators, insofar as they provide a software based implementation of a hardware architecture. Varieties of simulator computer programs include emulators, virtual machines, models, and binary translators, including dynamic binary translators. Typically, a simulator implementation may run on a host processor 715, optionally running a host operating system 710, supporting the simulator program 705. In some arrangements, there may be multiple layers of simulation between the hardware and the provided instruction execution environment, and/or multiple distinct instruction execution environments provided on the same host processor. Historically, powerful processors have been required to provide simulator implementations which execute at a reasonable speed, but such an approach may be justified in certain circumstances, such as when there is a desire to run code native to another processor for compatibility or re-use reasons. For example, the simulator implementation may provide an instruction execution environment with additional functionality that is not supported by the host processor hardware, or provide an instruction execution environment typically associated with a different hardware architecture. An overview of simulation is given in “Some Efficient Architecture Simulation Techniques”, Robert Bedichek, Winter 1990 USENIX Conference, Pages 53-63.

To the extent that embodiments have previously been described with reference to particular hardware constructs or features, in a simulated embodiment, equivalent functionality may be provided by suitable software constructs or features. For example, particular circuitry may be implemented in a simulated embodiment as computer program logic. Similarly, memory hardware, such as a register or cache, may be implemented in a simulated embodiment as a software data structure. In arrangements where one or more of the hardware elements referenced in the previously described embodiments are present on the host hardware (for example, host processor 715), some simulated embodiments may make use of the host hardware, where suitable.

The simulator program 705 may be stored on a computer-readable storage medium (which may be a non-transitory medium), and provides a program interface (instruction execution environment) to the target code 700 (which may include applications, operating systems and a hypervisor) which is the same as the interface of the hardware architecture being modelled by the simulator program 705. Thus, the program instructions of the target code 700 may be executed from within the instruction execution environment using the simulator program 705, so that a host computer 715 which does not actually have the hardware features of the apparatuses discussed above can emulate these features, these being provided by instruction fetch logic 701, processing logic 702, register logic 703, and memory security logic 704.

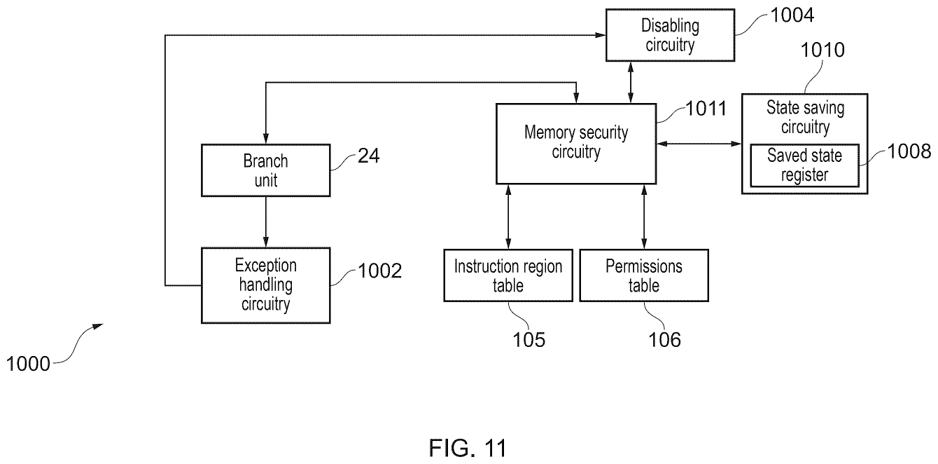

FIG. 11 illustrates an example apparatus 1000. In this example, the memory security circuitry 1011 is responsible for determining the permissions in respect of code that is executing to access one or more memory locations. The permissions might include the ability to execute at that memory location (e.g. by branching to a program address), to read at that memory location (e.g. via an LDR instruction) and to write at that memory location (e.g. by an STR instruction). The permissions can be determined in a number of ways and these may include by analysis of the program counter value of the executing code and the call stack of the executing code. The latter of these is particularly useful in library code where it may be desirable for the permissions of the library code caller to be assessed rather than the library code itself.

When an exception is to be called, it may be the case that the currently executing code is denied permission to access the exception handling routine (e.g. as may be determined using a PSTATE.TIndex and PSTATE.IPOIndex to index into an instruction region table 105, in order to index into a permissions overlay table 106 to obtain a set of permissions that are to be applied). Indeed, this may generally be the case since it is not desirable for arbitrary software to be able to access the exception handling routine at any time. However, it is also generally the case that an exception could be called at any time. It is therefore necessary for arbitrarily executing code to be able to branch to an exception handling routine.

The present technique resolves this by temporarily disabling the memory security circuitry when an exception is raised. Consequently, the usual permissions check that the currently executing code has the execute permission in respect of the exception handling routine is thereby prevented and so the branch is permitted regardless of what the executing code's permissions might actually be. This disabling is achieved by the disabling circuitry 1004 in response to a signal from exception handling circuitry 1002 that an exception has occurred.

State saving circuitry 1010 with a saved state register 1008 is also provided. This can be used for saving the state of the memory security circuitry 1011 (e.g. whether it is disabled or not) for use in more complicated scenarios, as will be discussed with respect to FIG. 13 for instance.

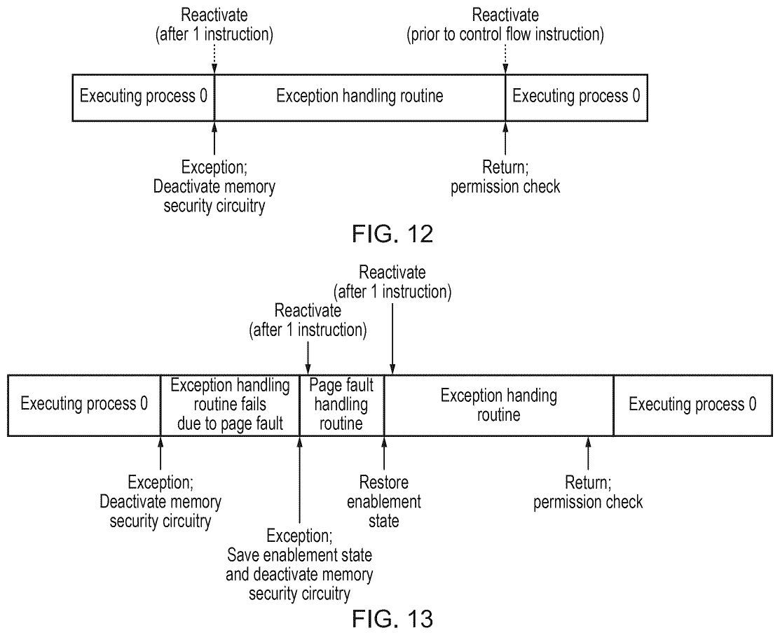

FIG. 12 shows a timeline of how such a disabling process might work. In this example, a process 0 is executing when an exception is raised. The raising of the exception causes the memory security circuitry 1011 to be disabled. The branch then occurs to the exception handling routine. Since the memory security circuitry 1011 has been disabled, no permissions check is made as to whether process 0 is permitted to branch to the exception handling routine or not. This might otherwise have been prohibited either by virtue of permissions applied to the instruction which caused the branch to the exception handling routine or by virtue of permissions applied to the first instruction of the exception handling routine. Disabling of the memory security circuitry may for example be achieved access to the processor state (PSTATE) register, by the setting/unsetting of a specific bit in that register (PSTATE.nOPX).

There are a number of possibilities for when the memory security circuitry 1011 can be enabled once more. In some examples, the reactivation occurs after one instruction—i.e. after the branch instruction that causes a branch into the exception handling routine. This process increases security since it means that the memory security circuitry is re-enabled as quickly as possible.

Another possibility is for the reactivation to wait until the next control flow instruction is encountered. This could be another branch instruction but it could also be a return from the exception handling routine. By keeping the memory security circuitry 1011 disabled until the next control flow instruction, the memory security circuitry 1011 is kept offline for as long as possible. This reduces the amount of computation required since it does not necessitate permission checks being performed for every instruction until a control flow instruction is encountered at which time the issue of permissions becomes relevant again. Note that this assumes that the exception handling routine will generally have access to read and write to any memory location. This could be a reasonable assumption to make, since the exception handling routine is often a privileged piece of software.

In any event, when the return control flow instruction is executed, a return to the execution of process 0 takes place. At that point, a permission check occurs in order to confirm that the exception handling routine is permitted to branch to process 0. In general this will be the case since it is known that the exception handling routine could be called at any time and therefore is permitted to branch to any point in the program.

FIG. 13 illustrates a more complicated example in which the exception handling routine is paged out when it is called. This results in a double fault.

As before, it is assumed that process 0 is executing when an exception occurs. Once again, the exception is raised and this causes the memory security circuitry 1011 to be disabled. A branch then occurs to the exception handling routine and consequently no permission check takes place. Here, however, the exception handling routine has been paged out (e.g. it is not in active memory) and so the branch cannot complete. This causes a page fault to occur, which is another type of exception. Ordinarily, with the branch instruction having been executed (albeit causing a fault) this would cause the memory security circuitry 1011 to be re-enabled. However, the generation of the page fault, which is an exception, causes the state of the memory security circuitry 1011 (i.e. disabled) to be saved (e.g. to the saved state register 1008). It also causes the memory security circuitry 1011 to be disabled in order to allow the branch to take place to the page fault handling routine. The memory security circuitry is then re-enabled and the page fault handling routine takes place, which causes the exception handling routine (that had been paged out) to be paged back in. At the end of the page fault handling routine, the enablement state of the memory security circuitry 1011 (from when the page fault was raised) is restored and the branch to the exception handling routine is attempted once more. This time, of course, the exception handling routine is in active memory and so the branch completes successfully. The rest of the process then proceeds as already described with the exception handling routine returning to process 0 via a permission check.

In the above description, therefore, it can be seen that the saved state register 1008 makes it possible to ‘defer’ the branch and the modification to the state of the memory security circuitry 1011 until such time as the exception handling routine is in active memory and thus a branch to that code can take place.

Note that in this example, the state of the memory security circuitry 1011 can be autonomously saved and restored (e.g. by the state saving circuitry 1010) to the saved state register 1008. Thus, whether or not there is permission to save the state of the memory security circuitry 1011 is not relevant.

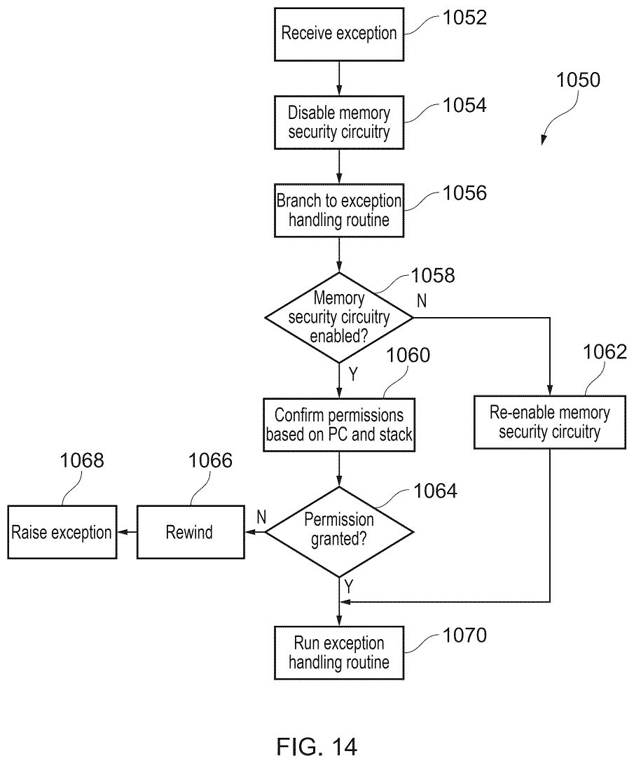

FIG. 14 illustrates a flow chart 1050 that shows a method of data processing in accordance with some examples. The process starts at step 1052 where an exception is received. Then, at step 1054, the memory security circuitry 1011 is disabled (e.g. via the disabling circuitry 1004). At a step 1056, a branch to the exception handling routine is affected. Then at step 1058, it is determined whether the memory security circuitry 1011 is enabled or not. Note that in practice, the circuitry or apparatus itself does not make this determination but instead the process that occurs is dependent on whether the memory circuitry 1011 is enabled or not. If the circuitry is enabled, then at step 1060 it is determined whether the permissions associated with the program counter and call stack allow the caller to access the target in one of the methods previously described. If at step 1064, it is determined that such permissions are not granted then at step 1066 the branch is rewound (e.g. by restoring the program counter to the branch instruction and by flushing the pipeline) and at step 1068 an exception is raised to identify that an illegal access took place. If permission is granted then the permission handling routine executes at step 1070.

If the security circuitry is not enabled at step 1058 then at step 1062, having performed the branch, the memory security circuitry 1011 is re-enabled and the process returns to step 1070 thereby bypassing the permissions check at step 1064.

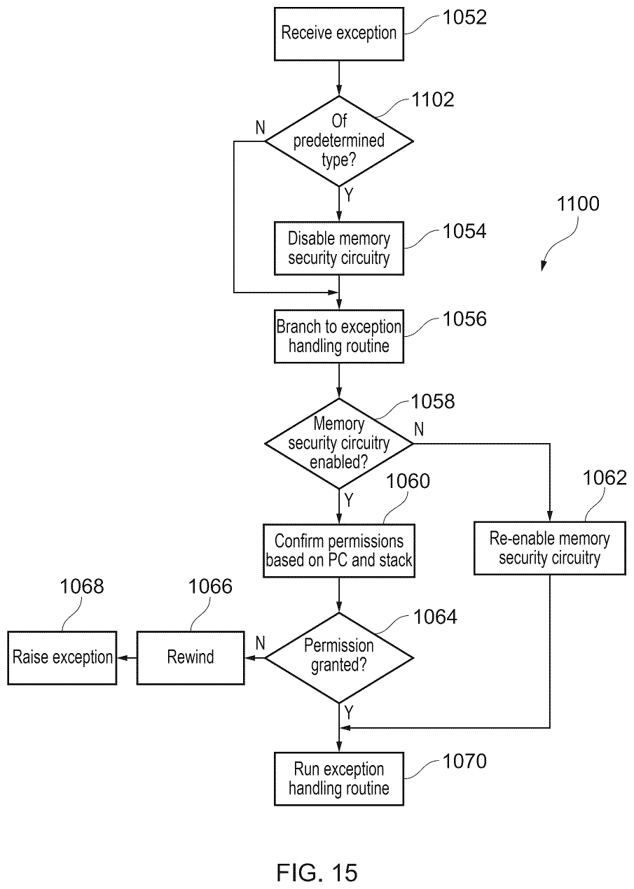

FIG. 15 illustrates a variant in which only certain types of exception cause the memory security circuitry 1011 to be disabled. The process is the same except that after step 1052 when the exception is received, it is determined whether the exception is of a predetermined type (or class, or in a set of types) at step 1102. If so, then at step 1054, the memory security circuitry 1011 disabled at step 1054. Otherwise, it is not and in either case the process proceeds to step 1056 where a branch to the exception handling routine takes place.

Thus in these examples, not all exceptions cause the memory security circuitry 1011 to be disabled. This makes it possible for security in respect of certain types of exception to remain. That is, for those particular exceptions, code must have permission to ‘execute’ the exception handling routine in order for the exception handling routine to be called by the raising of the exception. Such a situation might be desirable for types of exception that cannot be raised at any point in the program or for where extra security is desirable.

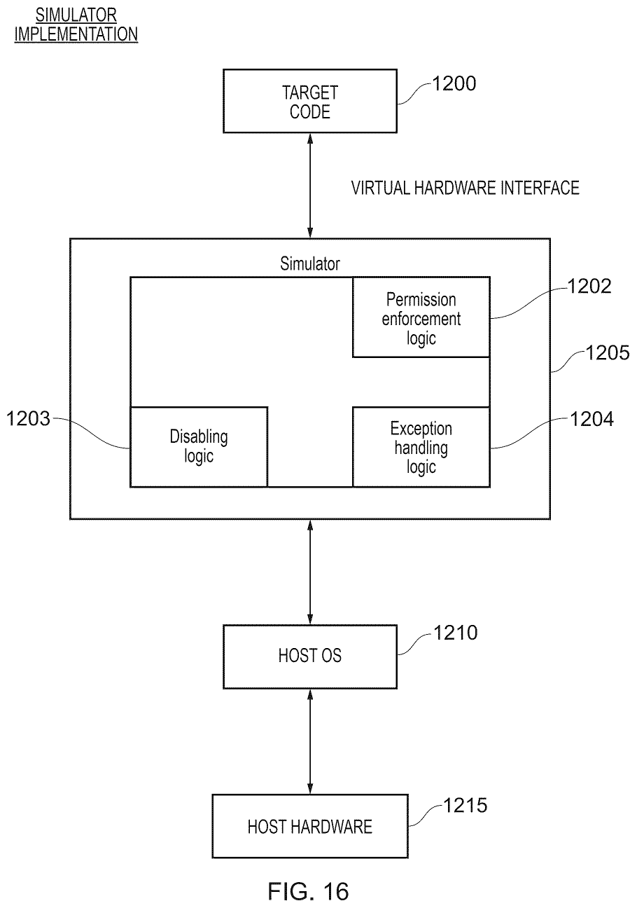

FIG. 16 schematically illustrates a simulator implementation that may be used. Whilst the earlier described embodiments implement the present invention in terms of apparatus and methods for operating specific processing hardware supporting the techniques concerned, it is also possible to provide an instruction execution environment in accordance with the embodiments described herein which is implemented through the use of a computer program. Such computer programs are often referred to as simulators, insofar as they provide a software based implementation of a hardware architecture. Varieties of simulator computer programs include emulators, virtual machines, models, and binary translators, including dynamic binary translators. Typically, a simulator implementation may run on a host processor 1215, optionally running a host operating system 1210, supporting the simulator program 1205. In some arrangements, there may be multiple layers of simulation between the hardware and the provided instruction execution environment, and/or multiple distinct instruction execution environments provided on the same host processor. Historically, powerful processors have been required to provide simulator implementations which execute at a reasonable speed, but such an approach may be justified in certain circumstances, such as when there is a desire to run code native to another processor for compatibility or re-use reasons. For example, the simulator implementation may provide an instruction execution environment with additional functionality that is not supported by the host processor hardware, or provide an instruction execution environment typically associated with a different hardware architecture. An overview of simulation is given in “Some Efficient Architecture Simulation Techniques”, Robert Bedichek, Winter 1990 USENIX Conference, Pages 53-63.

To the extent that embodiments have previously been described with reference to particular hardware constructs or features, in a simulated embodiment, equivalent functionality may be provided by suitable software constructs or features. For example, particular circuitry may be implemented in a simulated embodiment as computer program logic. Similarly, memory hardware, such as a register or cache, may be implemented in a simulated embodiment as a software data structure. In arrangements where one or more of the hardware elements referenced in the previously described embodiments are present on the host hardware (for example, host processor 1215), some simulated embodiments may make use of the host hardware, where suitable.

The simulator program 1205 may be stored on a computer-readable storage medium (which may be a non-transitory medium), and provides a program interface (instruction execution environment) to the target code 1200 (which may include applications, operating systems and a hypervisor) which is the same as the interface of the hardware architecture being modelled by the simulator program 1205. Thus, the program instructions of the target code 1200 may be executed from within the instruction execution environment using the simulator program 1205, so that a host computer 1215 which does not actually have the hardware features of the apparatuses discussed above can emulate these features, these being provided by permission enforcement logic 1202, disabling logic 1203 and exception handling logic 1204.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

Various configurations within the scope of the present disclosure are set out in the following numbered clauses.

Clause 1. Apparatus comprising:
memory security circuitry configured to respond to a branch by determining whether there is permission for the execution context that executes the branch to branch to the target of the branch and to take an error action in the absence of such permission;
exception handling circuitry configured to respond to an exception by branching to an exception handling routine; and
disabling circuitry configured to disable the memory security circuitry in response to the exception.

Clause 2. The apparatus according to Clause 1, wherein the disabling circuitry is configured to disable the memory security circuitry for one instruction.

Clause 3. The apparatus according to Clause 2, wherein execution of the one instruction is the cause of the branching to the exception handling routine.

Clause 4. The apparatus according to Clause 2, wherein the one instruction is a first instruction of the exception handling routine.

Clause 5. The apparatus according to any preceding Clause, comprising:
a current state register,
wherein the disabling circuitry is configured to disable the memory security circuitry in response to the exception in dependence on a disabling bit of the current state register.

Clause 6. The apparatus according to any one of Clauses 2-5, comprising:
a saved state register, wherein
in response to the exception handling routine being paged out and a memory fault being raised, the enablement state of the memory security circuitry is saved to the saved state register and restored when the exception handling routine is paged in.

Clause 7. The apparatus according to any one of Clauses 2-6, wherein the disabling circuitry is configured to re-enable the memory security circuitry after the one instruction has been executed.

Clause 8. The apparatus according to any one of Clauses 2-7, wherein the disabling circuitry is configured to re-enable the memory security circuitry in response to a further control flow instruction.

Clause 9. The apparatus according to any preceding Clause, wherein the memory security circuitry is configured to determine whether there is permission for the execution context that executes the branch to branch to the target of the branch after the branch has been performed.

Clause 10. The apparatus according to Clause 9, wherein the error action comprises rewinding the branch as if it had not taken place.

Clause 11. The apparatus according to any of Clauses 7-10, wherein the memory security circuitry is configured to store, for the execution context that executes the branch, whether the execution context is permitted to read, write and/or execute in relation to a memory location.

Clause 12. The apparatus according to any one of Clauses 7-11, wherein when the disabling circuitry has disabled the memory security circuitry, the execution context that executes the branch is permitted to branch to the exception handling routine regardless of whether the memory security circuitry stores an indication that the execution context is prohibited from branching to the exception handling routine.

Clause 13. The apparatus according to any preceding Clause, wherein the error action comprises raising an exception.

Clause 14. The apparatus according to any preceding Clause, wherein the memory security circuitry is configured to determine whether there is permission for the execution context that executes the branch to branch to the target of the branch based on a program counter value of the execution context.

Clause 15. The apparatus according to any preceding Clause, wherein the disabling circuitry is configured to disable the memory security circuitry in response to the exception in dependence on a type of the exception.

### Clause 16. a Method Comprising:

responding, using memory security circuitry, to a branch by determining whether there is permission for the execution context that executes the branch to branch to the target of the branch and taking an error action in the absence of such permission;
responding to an exception by branching to an exception handling routine; and
disabling the memory security circuitry in response to the exception.

Clause 17. A computer program for controlling a host data processing apparatus to provide an instruction execution environment, the computer program comprising:
permission enforcement program logic configured to respond to a branch by determining whether there is permission for the execution context that executes the branch to branch to the target of the branch and to take an error action in the absence of such permission;
   exception handling program logic configured to respond to an exception by branching to an exception handling routine; and
disabling program logic configured to disable the memory security circuitry in response to the exception.

Clause 18. A computer-readable storage medium to store the computer program of Clause 17.

In brief overall summary an apparatus is provided in which memory security circuitry responds to a branch by determining whether there is permission for the execution context that executes the branch to branch to the target of the branch and taking an error action in the absence of such permission. Exception handling circuitry responds to an exception by branching to an exception handling routine and disabling circuitry disables the memory security circuitry in response to the exception.

In the present application, the words “configured to . . .” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative embodiments of the invention have been described in detail herein with reference to the accompanying drawings, it is to be understood that the invention is not limited to those precise embodiments, and that various changes, additions and modifications can be effected therein by one skilled in the art without departing from the scope and spirit of the invention as defined by the appended claims. For example, various combinations of the features of the dependent claims could be made with the features of the independent claims without departing from the scope of the present invention.

We claim:

1. Apparatus comprising:
memory security circuitry configured to respond to a branch by determining whether there is permission for the execution context that executes the branch to branch to the target of the branch and to take an error action in the absence of such permission;
exception handling circuitry configured to respond to an exception by branching to an exception handling routine; and
disabling circuitry configured to disable the memory security circuitry in response to the exception.

2. The apparatus according to claim 1, wherein
the disabling circuitry is configured to disable the memory security circuitry for one instruction.

3. The apparatus according to claim 2, wherein
execution of the one instruction is the cause of the branching to the exception handling routine.

4. The apparatus according to claim 2, wherein
the one instruction is a first instruction of the exception handling routine.

5. The apparatus according claim 1, comprising:
a current state register,
wherein the disabling circuitry is configured to disable the memory security circuitry in response to the exception in dependence on a disabling bit of the current state register.

6. The apparatus according to claim 2, comprising:
a saved state register, wherein
in response to the exception handling routine being paged out and a memory fault being raised, the enablement state of the memory security circuitry is saved to the saved state register and restored when the exception handling routine is paged in.

7. The apparatus according to claim 2, wherein
the disabling circuitry is configured to re-enable the memory security circuitry after the one instruction has been executed.

8. The apparatus according to claim 2, wherein
the disabling circuitry is configured to re-enable the memory security circuitry in response to a further control flow instruction.

9. The apparatus according to claim 1, wherein
the memory security circuitry is configured to determine whether there is permission for the execution context that executes the branch to branch to the target of the branch after the branch has been performed.

10. The apparatus according to claim 9, wherein
the error action comprises rewinding the branch as if it had not taken place.

11. The apparatus according to claim 7, wherein
the memory security circuitry is configured to store, for the execution context that executes the branch, whether the execution context is permitted to read, write and/or execute in relation to a memory location.

12. The apparatus according to claim 7, wherein
when the disabling circuitry has disabled the memory security circuitry, the execution context that executes the branch is permitted to branch to the exception handling routine regardless of whether the memory security circuitry stores an indication that the execution context is prohibited from branching to the exception handling routine.

13. The apparatus according to claim 1, wherein
the error action comprises raising an exception.

14. The apparatus according to claim 1, wherein
the memory security circuitry is configured to determine whether there is permission for the execution context that executes the branch to branch to the target of the branch based on a program counter value of the execution context.

15. The apparatus according to claim 1, wherein
the disabling circuitry is configured to disable the memory security circuitry in response to the exception in dependence on a type of the exception.

16. A method comprising:
responding, using memory security circuitry, to a branch by determining whether there is permission for the execution context that executes the branch to branch to the target of the branch and taking an error action in the absence of such permission;
responding to an exception by branching to an exception handling routine; and
disabling the memory security circuitry in response to the exception.

17. A computer program for controlling a host apparatus to provide an instruction execution environment, the computer program comprising:
permission enforcement program logic configured to respond to a branch by determining whether there is permission for the execution context that executes the branch to branch to the target of the branch and to take an error action in the absence of such permission;
exception handling program logic configured to respond to an exception by branching to an exception handling routine; and
disabling program logic configured to disable the memory security circuitry in response to the exception.

18. A computer-readable storage medium to store the computer program of claim 17.
